(19) United States
(12) Patent Application Publication
(10) Pub. No.: US 2024/0276968 A1
(43) Pub. Date: Aug. 22, 2024

(54) Swatter

(71) Applicant: Keith Marz, Sherman Oaks, CA (US)

(72) Inventor: Keith Marz, Sherman Oaks, CA (US)

(21) Appl. No.: 18/112,459

(22) Filed: Feb. 21, 2023

(51) Int. Cl. A01M 3/02

(52) U.S. Cl. CPC A01M 3/02

(57) ABSTRACT

A swatter that is available in four design configurations. All design configurations comprise a hand section with an upper section and a lower section, with an opening on the hand section created when the upper section is attached to the lower section, and four or five internal finger channels that allow a person to insert a hand through the opening into the hand section. A swatting section is attached to the hand section with a plurality of overlapping vanes that create an accordion structure. The swatting section's first end is attached to the second end of the hand section either permanently or non-permanently with the non-permanently attachment allowing the swatting section to be removed from the hand section. The longitudinal length of the swatting section's first end is less than the second end, which causes vanes to fan outward as the vaners extend from the hand section.

### TECHNICAL FIELD

The invention generally pertains to fly swatters, and mom particularly to an swatter that can be worn like a glove, thereby allowing the swatter to function as an extension of a person's arm which provides significantly increased control, power and accuracy.

### BACKGROUND ART

Although there are billions of humans on the earth, there are many more living creatures who are referred to as bugs, insects or rodents. While most of these, which are commonly called pests, prefer to avoid humans and to just perform actions necessary for their survival, there is often interaction between humans and pests. One of the most frequent interactions, and the one that is most troublesome for humans, is when pests come into human living or work areas. A couple examples of this are when a housefly enters a residence or other enclosed location, or when ants come seeking food in a home or outside location where humans congregate (e.g., ants at a picnic).

There are many ways of compensating and eradicating unwanted pests. There are poisons that are applied by an exterminator, traps and consumer bug sprays. While most of these can be effective, especially in the short term, they do require effort and expense to implement.

Another device that has become an almost ubiquitous household tool is a fly swatter, and while being in use for an extremely long time for flies and other pests, is not entirely optimal.

A typical, or conventional, fly swatter is simply a shaft, with or without a handle on one end, and a usually square or round shaped swatting surface. Pretty much all fly swatters are made of plastic and if a pest, such as a housefly, is remaining still on a surface, a fly swatter can be successfully used. The problem is that houseflies and many other pests do not remain stationary at one spot, waiting to be swatted. In addition to moving (or flying) as a normal motion, most pests have eyes with which they can see an approaching human and take defensive measures.

What is needed is an improved design fly (or other pest), swatter. Optimally, a swatter would be made of a material that would be lightweight yet also durable, and could be quickly maneuvered to swat an insect, bug or even a small rodent while stationary or even flying (for those that have the capability). This could be accomplished by integrating the swatter with a person's hand. A glove-like structure, that could be worn on a hand, with a swatting surface extending outwardly, would produce the functionality of a swatter that is essentially an extension of a person's arm/hand. By using a swatter with this design/capability, a person would simply have to keep their eyes on the target (even if it is flying), and then direct the motion of the swatter where they are looking.

A search of the prior art did not disclose any literature or patents that read directly on the claims of the instant invention. However, the following U.S. patents are considered related:

| PATENT NO. | INVENTOR | ISSUED |
|---|---|---|
| D700,946 | Marz | Mar. 11, 2014 |
| 4,905,408 | Wu | Mar. 6, 1990 |
| 4,907,367 | Herman | Mar. 13, 1990 |
| 5,568,699 | Wadsworth | Oct. 29, 1996 |

The D700,946 patent discloses an ornamental design for a hand-held cloth insect swatter.

The U.S. Pat. No. 4,905,408 patent discloses an insect swatter including a frame having a pole which spans through the frame; a sticky sheet attached to the frame for trapping insects; and a handle formed with the pole of the frame. The frame has first protrusions and the pole has a second protrusion. The sticky sheet includes first holes for two first protrusions to pass through and second holes for the second protrusion to pass through such that the sticky sheet does not contact with any flat surface even when the insect swatter is horizontally placed on it.

The U.S. Pat. No. 4,907,367 patent discloses an insect swatter having substantially contiguous tines allowing swatting of insects on regular or irregular surface. The tyines are arranged to provide a planar surface for striking insects by minimizing the force applied so as to reduce lateral expulsion of insect bodily fluids.

The U.S. Pat. No. 5,568,699 patent discloses an insect swatter that allows swatting of insects without extrusion of the contents of the body casement. The swatter provides a handle having at one end a yoke that carries overfolded layers of a fabric swatting member that is attached to the yoke by a mortise and tenon-type joint. The swatting member is formed by two layers of nubbins. The end portion of the swatting member is formed by fingers, with a finger of one layer overlapping a slit between fingers of the adjacent layer.

For background purposes and indicative of the art to which the invention relates, reference may be made to the following remaining patents found in the patent search.

| PATENT NO. | INVENTOR | ISSUED |
|---|---|---|
| 2,441,290 | Rimer | May 11, 1940 |
| 3,648,402 | Siggers | Mar. 14, 1972 |
| 4,503,489 | Gott, et al | Jun. 10, 1986 |
| 4,898,171 | Dagenais | Nov. 29, 1988 |
| 6,851,218 | Conte | Feb. 8, 2005 |
| 7,739,830 | Wells | Jun. 22, 2010 |
| 9,854,794 | Bruls, et al | Feb. 28, 2017 |
| 2016/0278362 | Royal | Sep. 29, 2016 |

### DISCLOSURE OF THE INVENTION

A swatter that is available in four design configurations. The first design configuration comprises a hand section with an upper section including an outer surface and an inner surface; a lower section configured with the same dimensions as the upper section and also including an outer surface and an inner surface; a perimeter edge that extends along a first end, a first side, a second end and a second side; an opening located on the hand section's first end and that is created when the upper section is attached to the lower section; and four internal finger channels that allow a person to insert a hand through the opening into the hand section, with the person's thumb remaining outside of the hand section. A swatting section is attached to the hand section and comprises an inner end, an outer end, an upper surface, a lower surface, a perimeter edge, and a plurality of vanes in an overlapping configuration, creating an accordion structure. The swatting section's first end is attached to the second end of the hand section. The attachment can either be permanent or non-permanent, with the non-permanent attachment allowing the swatting section to be removed from the hand section. This functionality permits the swatting section to be cleaned separately from the hand section, or the swatting section to be removed and replaced if/when the swatting section becomes overly dirty or damaged. The longitudinal length of the swatting section's first end is less than the second end, which causes the accordion structure vanes to fan outward as the vanes extend from the hand section.

Both the hand section and the swatting section can be made of various materials including fabric, leather, suede, plastic, metal, nylon, rubber or a composite, with a lightweight, easy-to-handle material such as fabric preferred.

To increase the functionality and use of the insect swatter, the swatting section can have a non-stick or waterproof coating applied. Also, to increase the control and achieved force when using the swatter, especially when swatting an insect that is flying, an opening can be located at the end of each internal finger channel. The openings allow the ends of a person's finger to extend outward from the hand section's upper section. This configuration more fully allows the insect swatter to effectively function as an extension of a person's arm/hand, which leads to increased control and accuracy.

The only difference between the second design configuration and the first design configuration is that the second design configuration has five internal finger channels. This allows a person to insert their entire hand, including the thumb, into the hand section. The third design configuration replaces the glove-like hand section with a conventional handle that is grasped, and the fourth design configuration replaces the hand section with a gripping member that is located within a frame structure. For all configurations, a person will swing the insect swatter in the same manner as a typical fly swatter, except with the benefit of having the increased control and accuracy provided by the swatting section.

In view of the above disclosure, the primary object of the invention is to provide an insect swatter that is much more effective than a conventional fly swatter and can be used for insects that are stationary as well as insects that are flying.

In addition to the primary object, it is also an object of the invention to provide an insect swatter that:
is easy to use,
a can be used by adults and children,
a is durable and long-lasting,
can be used on many different types of insects, including those that walk/crawl or fly,
can be made in a larger size for big insects or other animals such as small rodents,
is effective for instant killing of an insect which reduces the likelihood of an insect suffering,
can be made to allow the swatting section to be easily removed from the hand section, thereby permitting a person to replace the swatting section whenever necessary or desired,
is easy to manufacture,
can be used indoors or outdoors, and
is cost effect from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic top view of a swatter with a hand section and a swatting section.

FIG. 2 is a top plan view of the swatter having openings at the distal end of finger channels within the hand section.

FIG. 3 is a bottom plan view of the swatter.

FIG. 4 is a rear elevational view of the swatter.

FIG. 5 is a front elevational view of the swatter.

FIG. 6 is a left side elevational view of the swatter, the right side being a mirror image.

FIG. 7 in an orthographic view of a person's hand prior to inserting four fingers into the four channels within the swatter's hand section.

FIG. 8 is an orthographic view of a person's entire hand prior to all fingers including the thumb being inserted into five channels within the swatter's hand section.

FIG. 9 is a top plan view of the swatter having the hand section replaced with a handle.

FIG. 10 is a top plan view of the swatter having the hand section replaced with a gripping assembly.

FIG. 11 is a top plan view of the swatter having the hand section replaced with a gripping assembly which further includes a horizontal stabilizing member.

### BEST MODE FOR CARRYING OUT THE INVENTION

The best mode for carrying out the invention is presented in terms that disclose a preferred embodiment, with four design configurations, of a swatter. One of the most prevalent problems that affects people throughout the world is the difficultly in dealing with bugs, insects and rodents (commonly referred to as pests). Whether it is a single housefly that enters a home or other undesirable living creatures, there is a strong and immediate desire to remove any/all pests. When an infestation occurs the normal course of action is to have a professional exterminator apply poison to the infested location(s). When the pest problem is smaller, consumers can use traps or sprays to eradicate the pests. One of the most common devices that is used by a single person is a fly swatter. As the name implies, a fly swatter is primarily designed to swat a wayward housefly that has entered a location where it is unwanted. Of course, a fly swatter can be used on pests other than houseflys. The design of a conventional fly swatter has remained unchanged for a very long time and typically consists of a plastic tool with a handle, a shaft and a square or round swatting surface. The problem with the conventional fly swatter design is that to be effectively used, the housefly or other pest must usually be stopped at a convenient location. It is almost impossible to swat a pest if it is flying, or even moving quickly on a surface.

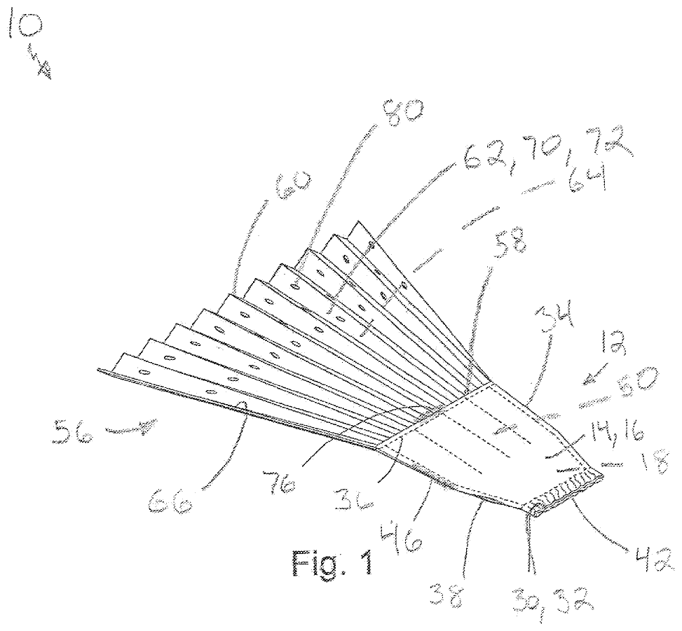

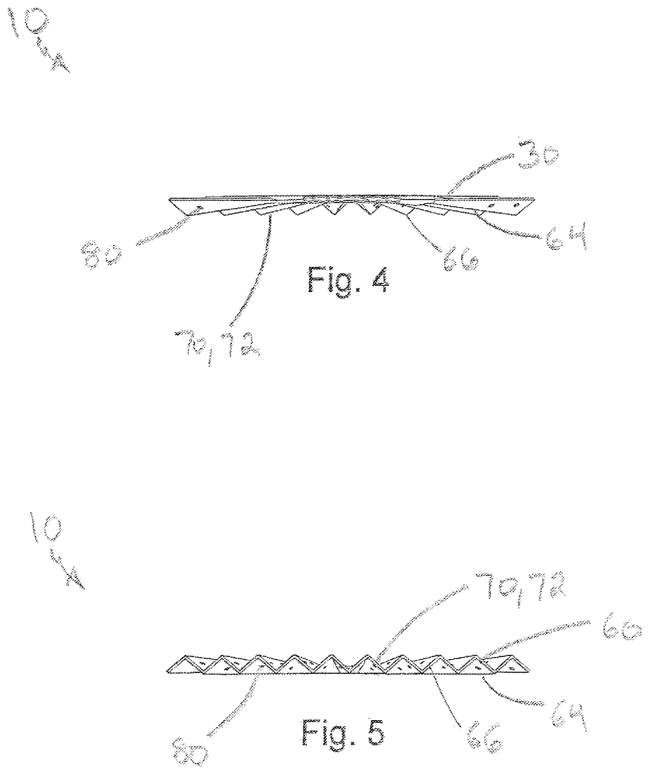

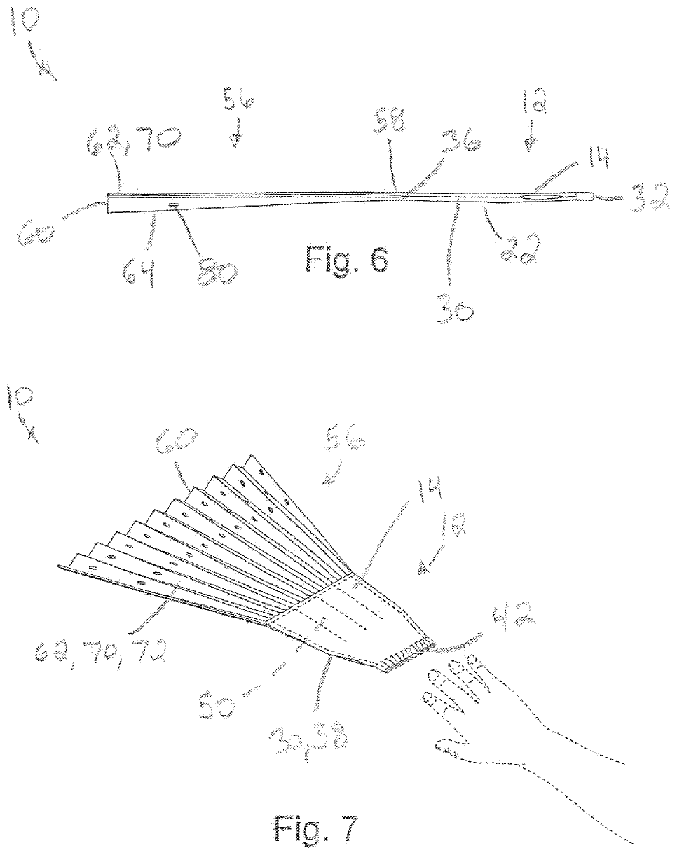

The swatter 10, as know as the SWAT IT and shown in FIGS. 1-11, provides an improved swatter design that allows a person to have much greater control and accuracy during the swatting action. The swatter 10 essentially becomes an extension of a user's arm/hand, thereby producing increased capability that allows even pests in flight to be swatted.

The first design configuration, as shown in FIGS. 1-7, is comprised of a hand section 12 and a swatting section 56. The hand section 12 includes an upper section 14 with an outer surface 16 and an inner surface 18. A lower section 22 is configured with the same dimensions as the upper section 14 and also has an outer surface 24 and an inner surface 26. A perimeter edge 30 extends around the band section 12, creating a first end 32, a first side 34, a second end 36 and a second side 38. An opening 42 is located on the hand section's first end 32, as shown in FIGS. 1-3, 7 and 8, and is created when the upper section 14 is attached, by attachment means 46, to the lower section 22. The attachment means 46 can be comprised of stitching, an adhesive, rivets, staples or being integrally secured during manufacture. Configured within the hand section 12 are four internal channels 50 that provide a separate location for each finger when a hand is inserted through the opening 42 into the hand section 12. For this design, only the four fingers are within the hand section 12, with the thumb remaining outside of the hand section 12. When the swatter 10 is made of a pliable material such as fabric, the channels are preferably created by stitching, as shown in FIGS. 1-3, although other means such as a rigid spacer could also be utilized.

The swatting section 56, as shown in FIGS. 1-3 and 6-9, is comprised of an inner end 58, an outer end 60, an upper surface 62, a lower surface 64 and a perimeter edge 66. A plurality of vanes 70 are in an overlapping configuration, creating an accordion structure, with the swatting section's first end 58 attached by attachment means 70 to the second end of the hand section 12. As shown in FIGS. 1-4 and 7-9, the swatting section's inner end 58 has a shorter longitudinal length than the swatting section's outer end 60 such that the accordion structure vanes 70 fan outward as the vanes extend from the hand section 12. In order to improve the aerodynamics of the swatting section 56, and to increase control/accuracy during use, them is at least one, and preferably two, perporations 80, as shown in FIGS. 1-9, extending through each of the vanes.

The attachment means 76 for attaching the swatting section 56 to the hand section 12 can be permanent or non-permanent. The permanent attachment means can include stitching, an adhesive, rivets, staples or integral securing during manufacture. The non-permanent attachment means allow the swatting section 56 to be removed from the hand section 12 for cleaning or replacement if the swatting section 56 becomes worn or damaged. The non-permanent attachment means can include non-permanent adhesive, standard tape, double-sided tape, a zipper, hook and loop fastener, snap closure, male and female detents, or a ziplock closer.

Both the hand section 12 and the swatting section 56 can be made of a variety of materials, including fabric, leather, suede, plastic, metal, nylon, rubber or a composite, with a fabric preferred.

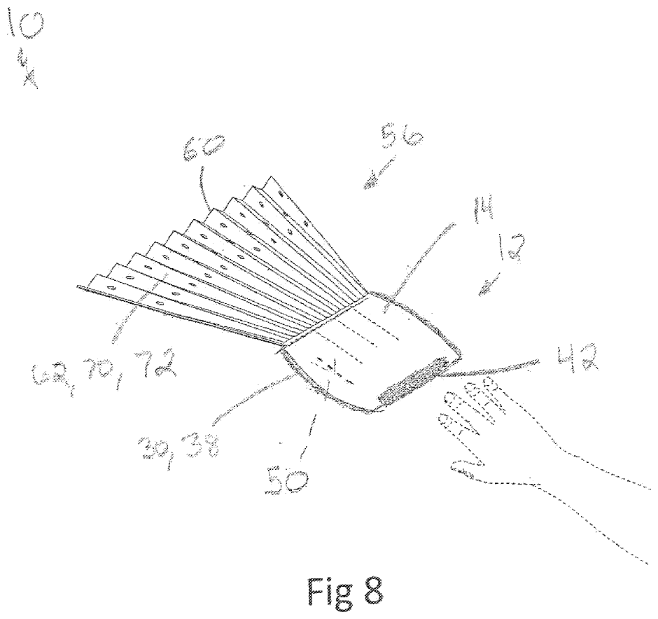

The second design configuration of the swatter 10 is similar to the first design configuration, with the only difference being that the second design configuration has five internal finger channels, as shown in FIG. 8, which allow a person to insert their entire hand, including the thumb, into the hand section 12 by way of the opening 42. Other than the additional channel for the thumb, the functionality and features of the second design configuration are the same as the first design configuration.

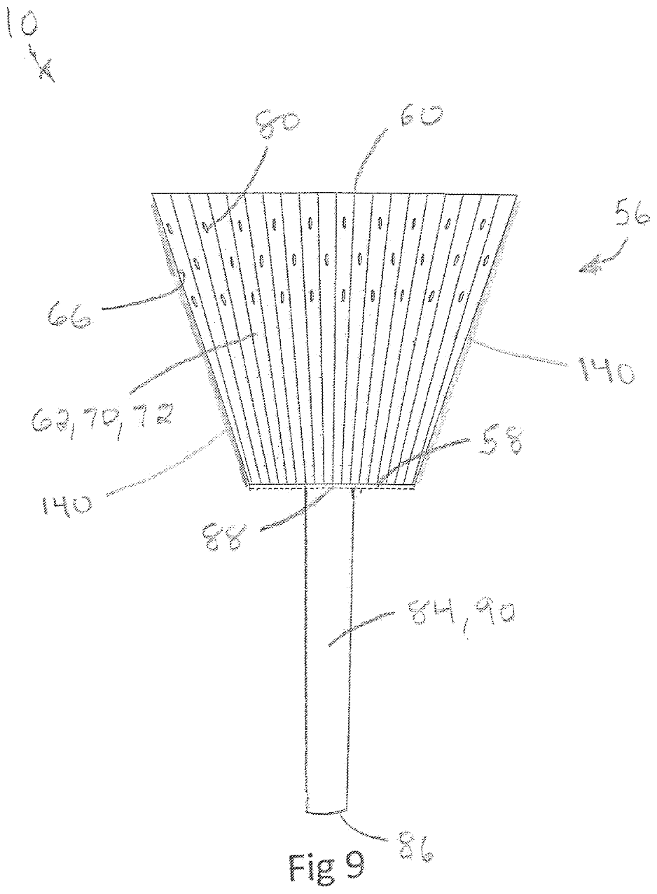

The third design configuration of the swatter 10 replaces the hand section 12 with a conventional handle 84. As shown in FIG. 9, the handle 84 has a first end 86, a second end 88, and a surface 90. While the hand section 12 does contribute to the improved design and the inventive concept as a whole, it is important to offer a design that provides a user with functionality that is familiar, so that those individuals who prefer to use a swatter with a design that they have become accustomed to and are comfortable with, can still benefit from the significantly improved capability the swatter's 10 swatting section provides.

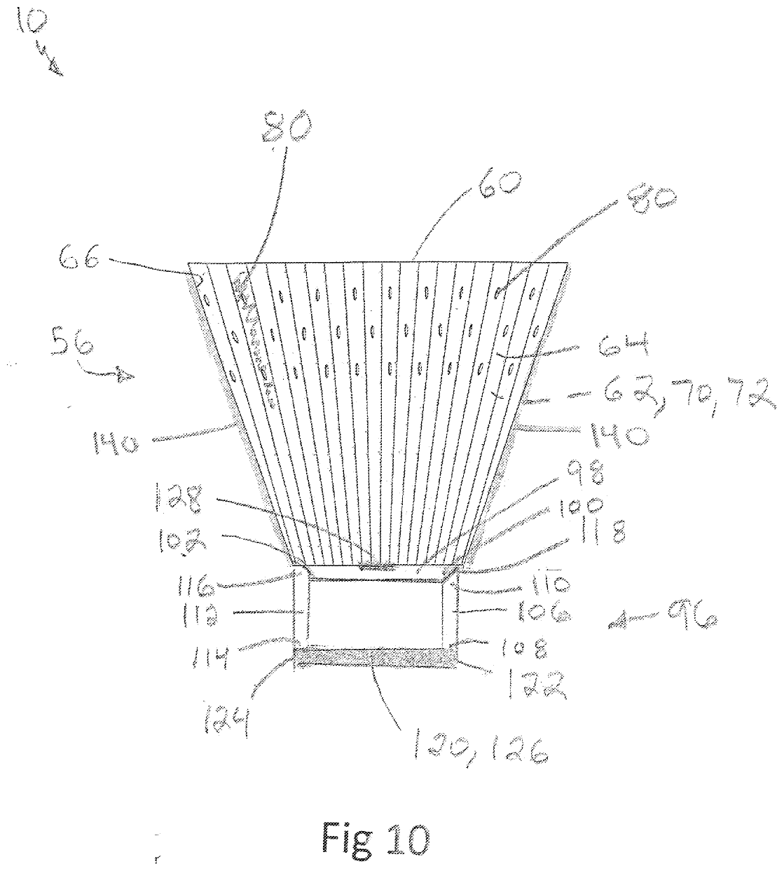

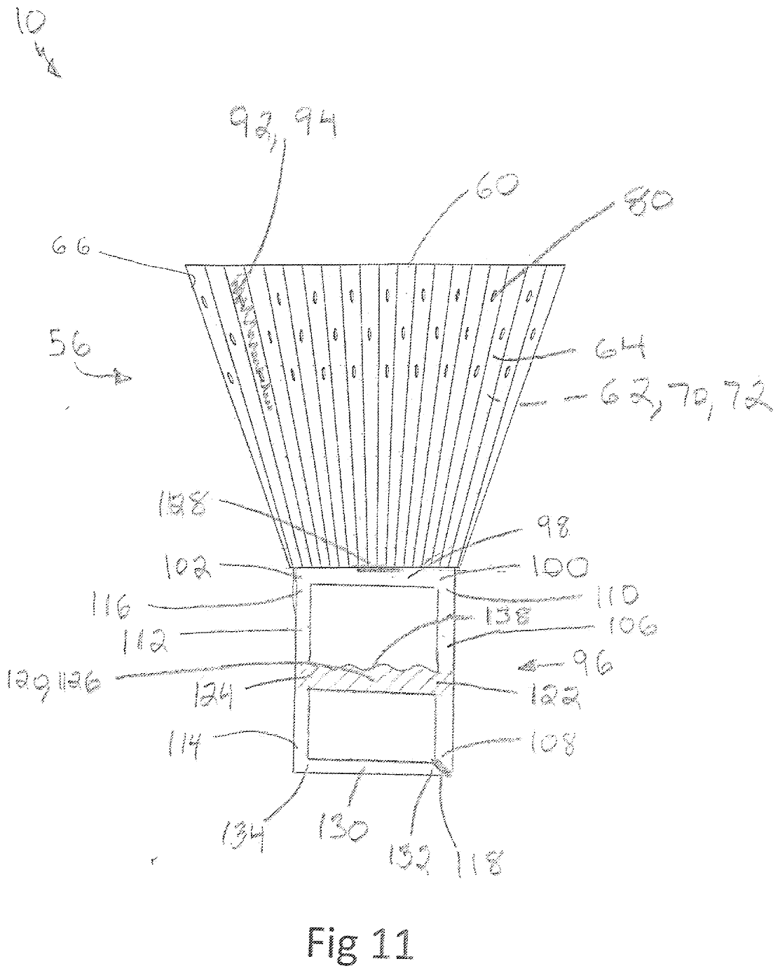

The fourth design configuration, as shown in FIGS. 10 and 11, replaces the hand section 12 with a gripping assembly 96. In a first embodiment, the gripping assembly 96 comprises a horizontal member 98 having a first end 100 and a second end 102. A first vertical member 106 has a first end 108 and a second end 110, with the second end 110 attached by attachment means 118 to the horizontal member's first end 100. The first vertical member 106 extends perpendicularly from the horizontal member 98. A second vertical member 112 also has a first end 114 and a second end 116, with the second end 116 attached by the attachment means 118 to the horizontal member's second end 102. As with the first vertical member 106, the second vertical member 112 extends perpendicularly from the horizontal member 98. When the two vertical members 106,112 are attached to the horizontal member 98, a square or rectangle shape with one side missing is created.

A gripping member 120 has a first side 122, a second side 124, and an outer surface 126. The first side 122 is attached by attachment means 128 at the first vertical member's first end 108 and the second side 124 is attached by the attachment means 128 at the second vertical member's first end 114.

The fourth design configuration also utilizes the same swatting section as the previous design configurations. The swatting section is attached to the gripping assembly 96 and comprises an inner end, an outer end, an upper surface, a lower surface and a perimeter edge. A plurality of vanes are in an overlapping configuration, creating an accordion structure. The swatting section's inner end is attached by attachment means to the horizontal member of the gripping assembly 96. The swatting section's inner end has a shorter longitudinal length than the swatting section's outer end, such that the accordion structure vanes fan outward as the vanes extend from the gripping assembly. To increase the aerodynamic functionality of the swatting section, at least one perforation extends through each of the vanes.

The attachment means 118 for attaching the horizontal member 98, the first vertical member 106, the second vertical member 112 together, as well as the gripping member 120 to the vertical members 106,112 can be selected from an adhesive, screws, welding or pins and slots. The attachment means 28 for attaching the swatting section to the gripping assembly can be permanent and selected from adhesive, rivets, staples, or integral securing during manufacture. The attachment means 28 can also be non-permanent, which allows the swatting section to be removed from the gripping assembly for cleaning or replacement if the swatting section becomes severely dirty or damaged. The non-permanent attachment means can be selected from non-permanent adhesive, standard tape, double-sided tape, a zipper, hook and loop fastener, snap closure, male and female detents, and a ziplock closer. To increase the functionality of the swatter, the gripping member 120 can have finger indentations 138 to provide a secure hand grip on the gripping member 120.

In a second embodiment of the gripping assembly/fourth design configuration, the assembly 96 can also include a horizontal stabilizing member 130 having a first end 132 and a second end 134. The first end 132 is attached by the attachment means 118 to the first vertical member's first end 108, and the second end 134 is attached by the attachment means 118 to the second vertical member's first end 114. The gripping member 120 is located at the substantial center, between the horizontal member 98 and the horizontal stabilizing member 130, as shown in FIG. 11.

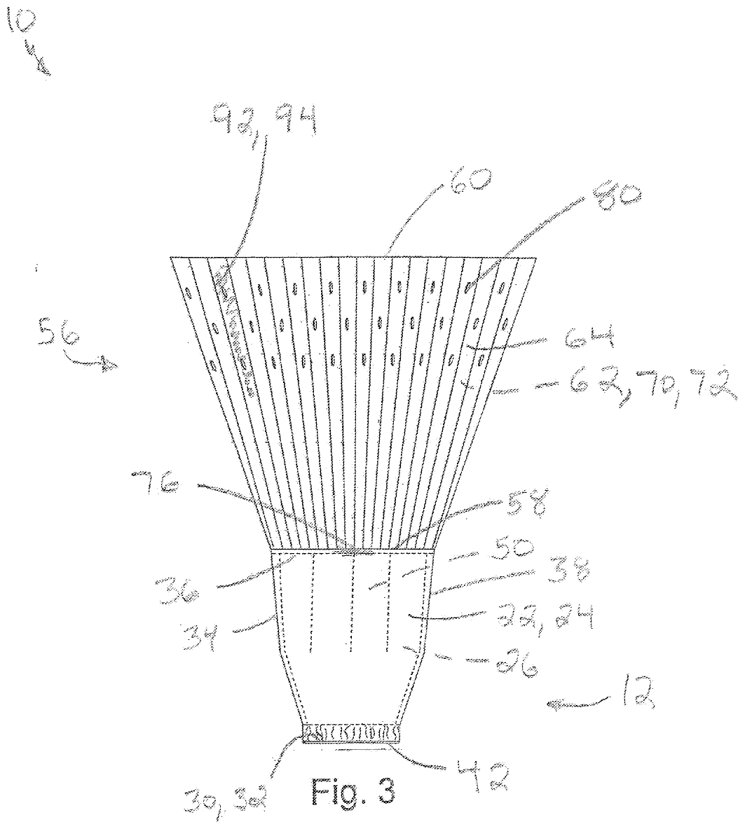

To increase the functionality and ease of use/care of the swatter 10, a coating 82, either a non-stick coating or a waterproof coating, or an anti-microbial coating, as shown in FIG. 3, can be applied onto the swatting section 56. Either coating 82 could make it much easier to use and clean the swatting section 56 as well as remove un-wanted remains that might adhere to the vanes.

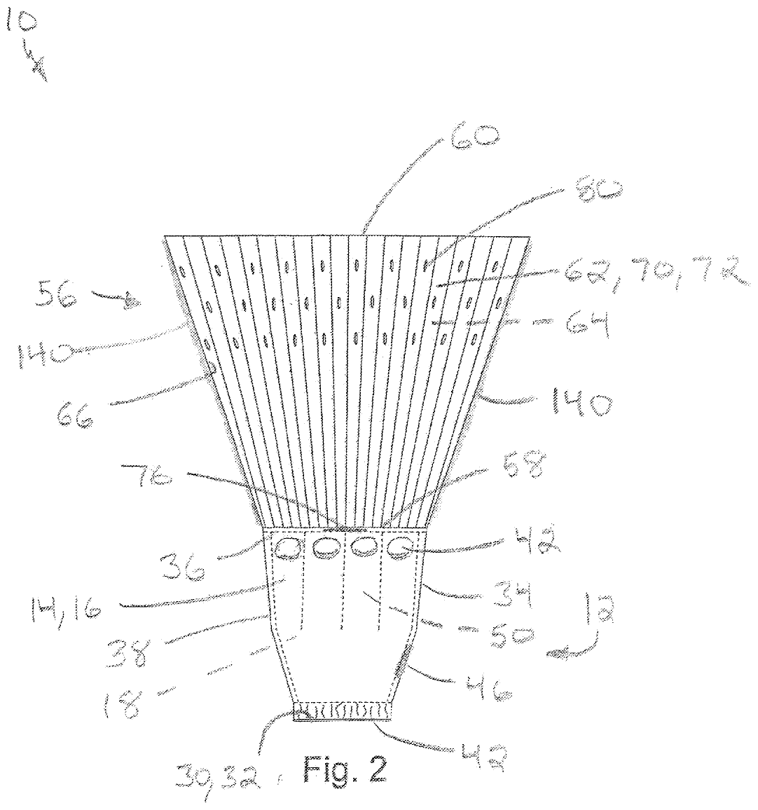

Also, in order to provide increased structural integrity to the vanes, and to maintain the vanes separated, without bunching up when the swatter 10 is in use, a separation and stability member 140 extends along the perimeter edge on the right and left sides, as shown in FIGS. 2, 7 and 8. The separation and stability members each are comprised of a strip of resilient material, such as plastic, and allow the swatting member accordion structure to be in an open, fanned orientation. When the swatter is swung in the air, or onto a surface, the separating and stability members ensure that the swatting section does not drop due to gravity or become entangled upon itself due to the swatting motion(s).

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A swatter comprising:
a hand section having:
an upper section comprising:
an outer surface,
an inner surface,
a lower section configured with the same dimensions as the upper section and comprising:
an outer surface,
an inner surface,
a perimeter edge that extends along a first end, a first side, a second end and a second side,
an opening located on the hand section's first end and that is created when the upper section is attached, by attachment means, to the lower section,
four internal finger channels configured within the hand section,
a swatting section comprising:
an inner end,
an outer end,
an upper surface,
a lower surface,
a perimeter edge,
a plurality of vanes in an overlapping configuration, creating an accordion structure, with the swatting section first end attached by attachment means to the second end of the hand section, and the first end with a shorter longitudinal length than the swatting section's second end such that the accordion structure vanes fan outward as the vanes extend from the hand section, and
at least one perforation extending through each of the vanes.

2. The swatter of claim 1, wherein the swatting section is made of a material selected from the group consisting of fabric, leather, suede, plastic, metal, nylon, rubber and a composite.

3. The swatter of claim 1, wherein the attachment means for attaching the swatting section to the hand section are permanent and selected from the group consisting of stitching, adhesive, rivets, staples, and integral securing during manufacture.

4. The swatter of claim 1, wherein the attachment means for attaching the swatting section to the hand section are non-permanent which allows the swatting section to be removed from the hand section and replaced, the non-permanent attachment means selected from the group consisting of a non-permanent adhesive, standard tape, double-sided tape, zipper, hook and loop fastener, snap closure, male and female detents, and a ziplock closer.

5. The swatter of claim 1, further comprising a non-stick coating that is applied onto the swatting section, the non-stick coating facilitates the removal of swatted insects and dirt from the vanes.

6. The swatter of claim 1, further comprising an anti-microbial coating that is applied onto the swatting section.

7. The swatter of claim 1, further comprising four openings, with one opening extending through the hand section's upper section at an end of each internal channel, adjacent the hand section's second end, each opening configured to allow an end of a finger within each channel to extend outward from the hand section's upper surface.

8. A swatter comprising:
a hand section having:
an upper section comprising:
an outer surface,
an inner surface,
a lower section configured with the same dimensions as the upper section and comprising:
an outer surface,
an inner surface,
a perimeter edge that extends along a first end, a first side, a second end and a second side,
an opening located on the hand section's first end and that is created when the upper section is attached, by attachment means, to the lower section,
five internal finger channels configured within the hand section and that allow a person to insert an entire hand through the opening and into the hand section,
a swatting section comprising:
an inner end,
an outer end,
an upper surface,
a lower surface,
a perimeter edge,
a plurality of vanes in an overlapping configuration, creating an accordion structure, with the swatting section first end attached by attachment means to the second end of the hand section, and the inner end having a shorter longitudinal length than the swatting section's outer end such that the accordion structure vanes fan outward as the vanes extend from the hand section, and
at least one perforation extending through each of the vanes.

9. The swatter of claim 8, wherein the swatting section is made of a material selected from the group consisting of fabric, leather, suede, plastic, metal, nylon, rubber and a composite.

10. The swatter of claim 8, wherein the attachment means for attaching the swatting section to the hand section are permanent and selected from the group consisting of stitching, adhesive, rivets, staples, and integral securing during manufacture.

11. The swatter of claim 8, wherein the attachment means for attaching the swatting section to the hand section are non-permanent which allows the swatting section to be removed from the hand section and replaced, the non-permanent attachment means selected from the group consisting of a non-permanent adhesive, standard tape, double-sided tape, zipper, hook and loop fastener, snap closure, male and female detents, and a ziplock closer.

12. The swatter of claim 8, further comprising a non-stick coating that is applied onto the swatting section, the non-stick coating facilitates the removal of swatted insects from the vanes.

13. The swatter of claim 8, further comprising an anti-microbial coating that is applied onto the swatting section.

14. The swatter of claim 11, further comprising four openings, with one opening extending through the hand section's upper section at an end of each internal channel, adjacent the hand section's second end, each opening configured to allow an end of a finger within each channel to extend outward from the hand section's upper surface.

15. A swatter comprising:
a gripping assembly comprising:
a horizontal member having a first end and a second end,
a first vertical member having a first end and a second end, the second end attached by attachment means to the horizontal member first end, and the first vertical member extending perpendicularly from the horizontal member,
a second vertical member having a first end and a second end, the second end attached by attachment means to the horizontal member second end, and the second vertical member extending perpendicularly from the horizontal member,
a gripping member having a first side, a second side, and an outer surface, the first side attached by attachment means at the first vertical member first end and the second side attached by the attachment means at the second vertical member first end,
a swatting section comprising:
an inner end,
an outer end,
an upper surface,
a lower surface,
a perimeter edge,
a plurality of vanes in an overlapping configuration, creating an accordion structure, with the swatting section inner end attached by attachment means to the horizontal member of the gripping assembly, and the inner end having a shorter longitudinal length than the swatting section's outer end such that the accordion structure vanes fan outward as the vanes extend from the handle, and
at least one perforation extending through each of the vanes.

16. The swatter of claim 15, wherein the swatting section is made of a material selected from the group consisting of fabric, leather, suede, plastic, metal, nylon, rubber and a composite.

17. The swatter of claim 15, wherein the attachment means for attaching the gripping assembly horizontal member to the first and second vertical members, and the gripping member to the first and second vertical members is selected from the group consisting of adhesive, screws, welding and pins and slots.

18. The swatter of claim 15, wherein the attachment means for attaching the swatting section to the gripping assembly are permanent and selected from the group consisting of adhesive, rivets, staples and integral securing during manufacture.

19. The swatter of claim 15, wherein the attachment means for attaching the swatting section to the gripping assembly are non-permanent which allows the swatting section to be removed from the gripping assembly and replaced, the non-permanent attachment means selected from the group consisting of a non-permanent adhesive, standard tape, double-sided tape, zipper, hook and loop fastener, snap closure, male and female detents, and a ziplock closer.

20. The swatter of claim 15, further comprising a non-stick coating that is applied onto the swatting section, the non-stick coating facilitates the removal of swatted insects from the vanes.

21. The swatter of claim 15, further comprising an anti-microbial coating that is applied onto the swatting section.

22. The swatter of claim 15, further comprising a horizontal stabilizing member having a first end and a second end, the first end attached by the attachment means to the first vertical member first end and the second end attached by the attachment means to the second vertical member first end, and with the gripping member located at the substantial center between the horizontal member and the horizontal stabilizing member.
